(19) United States
(12) Patent Application Publication
(10) Pub. No.: US 2012/0263011 A1
(43) Pub. Date: Oct. 18, 2012

(54) APPARATUS AND METHOD FOR APPLYING OSCILLATORY MOTION

(76) Inventors: Xiongwei NI, Ravelston (GB); Andrew FITCH, Airdrie (GB); Ian LAIRD, Mearnskirk (GB)

(21) Appl. No.: 13/532,003

(22) Filed: Jun. 25, 2012

Related U.S. Application Data
(63) Continuation of application No. 12/092,217, filed on Sep. 11, 2008.

(30) Foreign Application Priority Data
Nov. 15, 2005 (GB) 0523245.9

(51) Int. Cl. B01F 11/00; H02P 31/00

(52) U.S. Cl. 366/116; 318/126

(57) ABSTRACT

A method and apparatus for applying oscillatory motion to a substance in a vessel to provide improved mixing, in particular to enable different mixing patterns to be applied to a substance in a vessel without “stop, change and start” protocol, has a member and a control means operatively linked such that the movement of the member is determined by a control signal generated by the control means.

The present invention relates to an improved apparatus and method for applying oscillatory motion.

Oscillatory motion is of particular importance in many processes that are dependant on mixing. For example, the oscillatory motion produced and applied when using mixing in the chemical, petroleum, process, pharmaceutical, bioscience, bioengineering, food and associated industries can be critical on the process taking place and the final product obtained. In particular, the use of oscillatory baffled apparatus can be beneficial for carrying out mixing processes in these industries.

Currently, oscillation is imparted on the contents of an oscillatory baffled apparatus using an oscillator unit comprising an oscillator and a drive unit. These are essential in order to convert rotary motion from a motor into a reciprocating linear motion. The linear motion is then imparted on the contents of the oscillatory baffled apparatus to generate uniform mixing of liquid-liquid, gas-liquid and solid-liquid species.

The degree of mixing in oscillatory baffled apparatus can be controlled by fine tuning oscillation frequency and oscillation amplitude, using a pre-selected baffle type, and a predetermined baffle spacing and restriction area. The oscillator unit commonly comprises a motor, an inverter and a flywheel arrangement. The motor and inverter provide the rotary motion, and also the frequency of oscillation, which is typically 0.5 to 10 Hz. Various types of pneumatic, hydraulic, magnetic and mechanical motors have been used as the oscillator unit in oscillatory baffled apparatus. Rotary motion can be converted to reciprocating linear motion via the bell house linkage on a flywheel, or a moving rod on a converging cone. The oscillation amplitudes so created can be changed by adjusting the eccentric position of the bell house linkage on the flywheel off-line, or by moving the linkage rod on the rotating cone on-line.

However, present apparatus available for carrying out such processes suffers from several drawbacks and disadvantages. For example, the oscillator unit arrangements have obvious limitations in that the determination of oscillation amplitude is inaccurate. Moreover, a “stop, change and start” operational protocol must be employed for changing oscillation amplitude when using a flywheel arrangement. That is, whenever the amplitude of oscillation is changed, the process in hand must be stopped and the eccentric position of the bell house link on the flywheel must be manually adjusted. Moreover, present apparatus is restricted to imparting sinusoidal oscillatory motion only.

Therefore it is an object of the present invention to overcome at least some of the drawbacks associated with the prior art.

According to a first aspect of the present invention there is provided an apparatus for applying oscillatory motion to at least one substance within a vessel, the apparatus comprising:
at least one member for applying motion to the at least one substance; and
a control means adapted to control the movement of the at least one member
   wherein the movement of the at least one member is determined by a control signal generated by the control means.

According to a second aspect of the present invention there is provided an apparatus for applying oscillatory motion to at least one substance within a vessel, the apparatus comprising:
a vessel;
at least one baffle extending inwards from the side of the vessel;
at least one member for applying motion to the at least one substance; and
a control means adapted to control the movement of the at least one member
   wherein the movement of the at least one member is determined by a control signal generated by the control means.

The control signal is generated in accordance with at least one predetermined waveform.

Optionally the control signal has a first predetermined waveform and the control means is adapted to switch the control signal to a second alternative waveform.

The waveform describes the control signal output which is applied to the at least one member.

The vessel may be closed at one or both ends to allow processing of substances in batches, or may be open at both ends to allow continuous processing of substances.

Optionally at least part of the at least one member is moveably located within the vessel.

Alternatively the at least one member operates on a diaphragm or bellows or a piston arrangement connected to the vessel.

The substance can be a mixture of miscible or immiscible fluids; a reaction mixture of a chemical reaction; a dispersion, suspension, emulsion or micro-emulsion; or any other suitable material with at least some fluid properties.

The apparatus of the present invention facilitates the alteration of the control signal waveform, and therefore the type of linear motion of the reciprocating means. Consequently, the mixing imparted on the contents of the apparatus is modifiable without interrupting the process that is being performed. The control signal waveform can be square wave, triangular wave, sinusoidal, irregular or any type of waveform.

Furthermore, the oscillation amplitude can be increased or decreased without the “stop, change and start” protocol and the oscillation frequency and amplitude can be altered simultaneously or independently.

Preferably the at least one member is an actuator.

More preferably, the actuator is a reciprocating linear actuator.

The actuator can comprise a reciprocating shaft.

Optionally the actuator further comprises a piston attached to the reciprocating shaft.

The apparatus may further comprise at least one baffle set.

The at least one baffle set may be attached to a reciprocating shaft so forming an actuator.

The baffle set may have a plurality of annular baffles, which may be joined together by rails in a substantially equidistant manner, and arranged substantially in parallel, such that they extend radially inwards from the side of the vessel. In a batch oscillatory apparatus, the last baffle in a baffle set is the baffle closest to the base of the batch apparatus. The baffle set may form part of the actuator or can be static, fixed to the inside of the vessel.

Preferably the control means is a servo amplifier.

More preferably the control means is a digital servo amplifier.

The control means affords the user complete control over the control signal, and thus type of waveform imparted on the reciprocating means (i.e. sinusoidal, square-wave, triangular-wave, irregular wave). The control means accurately controls the position of the shaft within the actuator, and therefore controls the oscillation. The control means can therefore generate various forms of reciprocating motion that are subsequently executed by the actuator, imparting programmed motion on the substance in the apparatus.

The actuator and the control means are combined to form an oscillator unit.

According to a third aspect of the present invention there is provided a method for applying oscillatory motion to at least one substance within a vessel using at least one member, the method comprising the steps of:
generating a control signal having a controllable waveform;
applying the control signal to the at least one member; and
moving the at least one member to apply oscillatory motion to the at least one substance
   wherein the movement of the at least one member is determined by the control signal.

According to a fourth aspect of the present invention there is provided a method of mixing at least one substance within a vessel using at least one member, the method comprising the steps of:
generating a control signal having a controllable waveform;
applying the control signal to the at least one member; and
moving the at least one member to apply oscillatory motion to the at least one substance
   wherein the movement of the at least one member is determined by the control signal.

Preferably the method comprises the further step of switching the control signal applied to the at least one member to an alternative controllable waveform to apply an alternative oscillatory motion to the at least one substance.

The control signal can be switched to an alternative waveform in response to conditions within the vessel.

Optionally the control signal is adapted to produce a waveform that is substantially sinusoidal.

Alternatively the control signal is adapted to produce a waveform that is substantially square wave.

A further alternative is that the control signal is adapted to produce a waveform that is substantially triangular wave.

A still further alternative is that the control signal is adapted to produce a waveform that is irregular.

The control signal can be adapted to produce a waveform with constant or variable amplitude.

The control signal can be adapted to produce a waveform with constant or variable frequency.

The control signal can be adapted to produce a waveform with constant or variable period.

Preferably, on adjustment of the amplitude in a batch apparatus comprising a last baffle, the last baffle is automatically realigned in relation to the bottom of the apparatus. This can be carried out prior to the start of operation, using a pre-set peak-to-peak amplitude method to determine a reference position.

The at least one member can be set to a pre-determined position prior to the start of operation.

In a continuous oscillatory baffled reactor the actuator automatically squeezes the bellows so that flushing can be carried out to remove air or impurity within continuous oscillatory baffled reactor. In batch oscillatory baffled reactor where the baffles are stationary, the squeezing also takes place, prior to the start of operation.

The present invention will now be described by way of example only, with reference to the accompanying drawings in which:

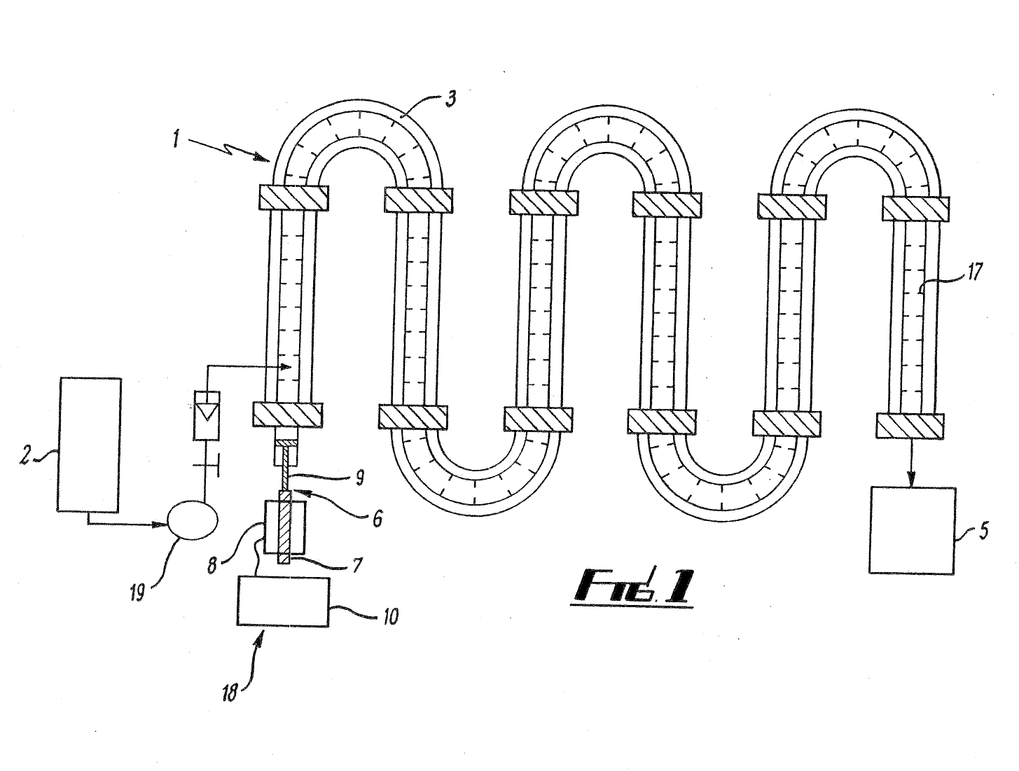

FIG. 1 shows schematic representation of a continuous oscillatory baffled apparatus; and

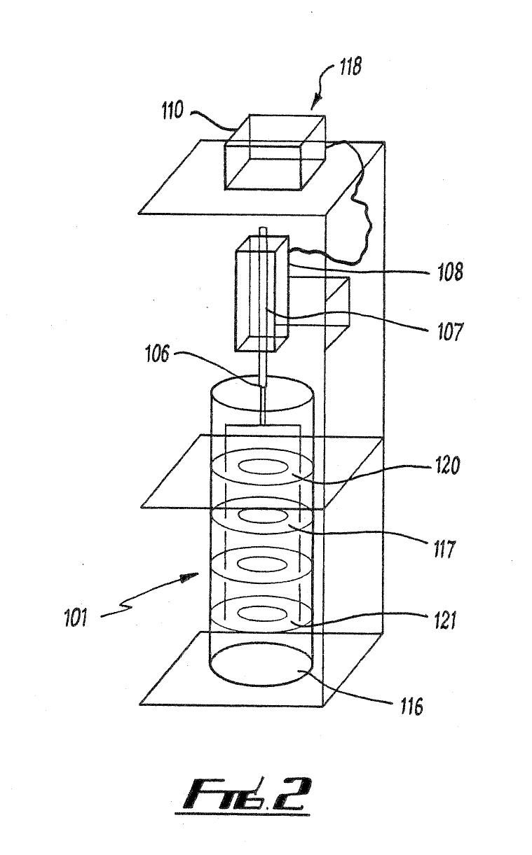

FIG. 2 shows a schematic representation of a batch oscillatory baffled apparatus.

Referring to FIG. 1, in this embodiment of the invention there is illustrated a continuous oscillatory baffled apparatus 1, with a serpentine flowpath. The oscillatory baffled apparatus 1 is shrouded by a heat removal jacket 3. Inside the oscillatory baffled apparatus 1 are annular baffles 17 that extend radially inwards from the sides of the oscillatory baffled apparatus 1. Attached to the oscillatory baffled apparatus 1 is an oscillator unit 18. At one end of the oscillatory baffled apparatus 1 there is connected a feed tank 2 and pump 19. At the other end of the oscillatory baffled apparatus there is connected a product tank 5.

The oscillator unit 18 comprises an actuator 6 which is made of a magnetic substance such as iron, and which constitutes a movable cylindrical shaft 7 connected to a cylindrical piston 9. The cylindrical shaft 7 is housed in a housing case 8. The movable cylindrical shaft 7 is longer than the dimensions of the housing case 8 with which its longest dimension is aligned so that the movable cylindrical shaft 7 moves in and out of both ends of the housing case 8.

In this example the actuator incorporates an IP67 rated forcer and a sealed stainless steel thrust rod enclosing rare-earth magnets, delivering a continuous force range of 100˜300 N with peak forces up to 1800 N, and stroke lengths from 20 to 320 mm. The oscillation unit can comprise any reciprocally movable shaft suitable for imparting linear motion, and any housing case suitable for housing said movable shaft. It will be appreciated that the actuator can also work by way of pneumatics or hydraulics.

The actuator acts as a member for applying motion to the contents of the vessel, and contains a reciprocating shaft attached to a piston. The reciprocating shaft could alternatively be attached to a baffle set.

The actuator 6 is controlled by a control box 10 in which a servo amplifier (not shown), together with an electronic assembly (not shown), are co-located. The control box 10 can be located close to the actuator 6 or remote from it.

In this example the control box acts as control means and incorporates a digital servo amplifier, which gives complete digital control of brushless or brush motors in an off-line powered package. It also accurately dictates the position of the shaft within the actuator and generates and executes various forms of reciprocating motions. The digital servo amplifier operates as a motion control device and a control signal generator, with a 16-position rotary switch for programming. In this example, the control box is connected to the actuator via a 5-pin socket for power supply and a 9-pin parallel connector for programming.

The control box offers an easy to use button press means for changing oscillation amplitude. The oscillation amplitude can be determined to 230 μm accuracy, and with 10 μl repeatability. The control box eliminates the need for the traditional “stop, change and start” operational protocol that has been used previously for apparatus with a bell house linkage on a flywheel.

A liquid phase containing a first reactant is pumped into the continuous oscillatory baffled apparatus 1 from a feed tank 2. Further reactants are added sequentially downstream from the addition of the first reactant. A reaction takes place along the length of the apparatus 1 with heat removal by the jackets 3 containing a coolant. Oscillation is provided by the oscillation unit 18. The product is continuously produced and discharged to the product tank 5.

Referring now to FIG. 2, in an alternative embodiment of the invention there is illustrated a batch oscillatory baffled apparatus 101. Inside the oscillatory baffled apparatus 101 are annular baffles 117 that extend radially inwards from the sides of the oscillatory baffled apparatus 101. Attached to the oscillatory baffled apparatus 101 is an oscillator unit 118. The oscillator unit 118 comprises an actuator 106 which constitutes a movable shaft 107 connected to a baffle set 120. The movable shaft 107 is housed in a housing case 108. The baffle that is furthest from the actuator 106, and closest to the bottom 116 of the oscillatory baffled apparatus 101, is the last baffle 121.

Automatic realignment of the location of last baffle in relation to the bottom of a batch oscillatory baffled apparatus vessel can be performed for any chosen oscillation amplitude.

The actuator 106 is controlled by a control box 110 in which a servo amplifier (not shown), together with an electronic assembly (not shown), are co-located.

In this embodiment, the oscillator unit 118 provides the reciprocating motion for the baffle set 120. This oscillation generates the uniform mixing of fluids in the batch oscillatory baffled apparatus 101. A control box 110 can be located either close to the actuator 106 or remote from it. The oscillation unit 118 also automatically adjusts the position of the last baffle 121 in the baffle set 120 in relation to the bottom 116 of the batch oscillatory baffled apparatus 101 for any given oscillation amplitude, ensuring a regular distance between the last baffle 121 and the bottom 116 of the oscillatory baffled apparatus 101. The last baffle 121 can be moved independently of or in unison with the remaining baffles 117 in the baffle set 120.

This automated adjustment provides consistent fluid mechanical conditions within the batch oscillatory baffled apparatus for any amplitude and eliminates the “stop, change and start” operational protocol that has previously been necessary for apparatus with a bell house linkage on a flywheel.

It is desirable to have optimal spacing between the last baffle and the bottom of the oscillatory baffled apparatus to ensure optimal eddy motion. If the distance between the last baffle and the bottom of the apparatus is too large, then the eddies generated in this part of the apparatus will not be strong enough to provide uniform mixing. For example, if the apparatus contains a solid suspended in a fluid, the solid may settle towards the bottom of the apparatus. Similarly, if the distance between the last baffle and the bottom of the apparatus is too small, then the eddies generated in this part of the apparatus will be too strong to provide uniform mixing. Both of these situations result in a mixing gradient, which is undesirable.

In further alternative embodiments the vessel contains a diaphragm, or bellows, or a piston arrangement at one end. The baffle set is stationary within the vessel and the actuator periodically acts on the diaphragm, bellows or piston arrangement to create oscillatory motion and/or mixing within the vessel.

Use of the apparatus of FIG. 2 will now be described with reference to the flocculation process in waste water treatment. In this operation, wastewater of a known amount is charged into the batch oscillatory baffled apparatus, and mixing takes place by reciprocating the baffle set using the oscillation unit. Charged polymers are then added to the apparatus.

Traditionally a short period of high mixing intensity is required to uniformly disperse the polymer particles in wastewater, and is then followed by a longer period of low mixing intensity in order to allow charged polymer particles to “grab” wastes contained in solution to form flocs that are large enough to settle and be separated from the vessel.

In the apparatus of the prior art, this can only be done by changing the motor rotary motion, and hence altering the oscillation frequency in the oscillatory baffled apparatus. However, it is impracticable to alter the oscillation amplitude and examine the effect of changing oscillation amplitude on the flocculation rate, as this would involve a “stop, change and start” protocol. Furthermore, it is impossible to alter the form of the reciprocating motion and investigate the effect of the types of the oscillatory motion on the flocculation rate using the apparatus of the prior art.

In contrast, using the apparatus of the present invention, this process can be easily achieved through the following routes: changing the oscillation frequency at a fixed oscillation amplitude; changing the oscillation amplitude at a fixed frequency, which has not previously been practical; changing both the oscillation frequency and amplitude simultaneously or independently, which was not previously feasible; using different types of reciprocating waveform, which was previously impossible; using a sinusoidal form as in known, but having variable amplitudes and variable frequencies simultaneously or independently, which was not previously achievable; and optimising the reciprocating wave form for this process, which again was not previously possible.

The apparatus of the present invention enables any form of reciprocating motion to be generated and executed, including sinusoidal, square wave, triangle wave and irregular wave. The form of oscillatory motion has a significant effect on the degree of mixing achieved in oscillatory baffled apparatus and, in turn, the consistency and quality of the final products.

The apparatus has the ability to generate any desired form of reciprocating motion and to switch between different types of reciprocating motion in oscillatory baffled apparatus; this was not previously possible. Thus, the improved apparatus and method for applying oscillatory motion offers substantially greater control over the processes and products that can be performed and obtained from oscillatory baffled apparatus.

The method and apparatus have applications in providing improved mixing. In particular, the method and apparatus enable different mixing patterns to be applied to a substance in a vessel.

Improvements and modifications may be incorporated herein without deviating from the scope of the invention.

1. A method for applying oscillatory motion to at least one substance within a vessel using a reciprocating linear actuator for applying linear motion to the at least one substance, the method comprising the steps of:
generating a control signal having a controllable waveform;
applying the control signal to the reciprocating linear actuator; and
moving the reciprocating linear actuator to apply linear oscillatory motion to the at least one substance wherein the linear movement of the reciprocating linear actuator is determined by the control signal and wherein the frequency and amplitude of said linear movement is determined by the control signal, the control signal being generated in accordance with at least one predetermined waveform, and wherein the frequency and amplitude of the linear movement can be altered simultaneously or independently.

2. A method of mixing at least one substance within a vessel using a reciprocating linear actuator for applying linear motion to the at least one substance, the method comprising the steps of:
generating a control signal having a controllable waveform;
applying the control signal to the reciprocating linear actuator; and
moving the reciprocating linear actuator to apply linear oscillatory motion to the at least one substance wherein the linear movement of the reciprocating linear actuator is determined by the control signal and wherein the frequency and amplitude of said linear movement is determined by the control signal, the control signal being generated in accordance with at least one predetermined waveform, and wherein the frequency and amplitude of the linear movement can be altered simultaneously or independently.

3. A method as described in claim 1, comprising the further step of switching the control signal applied to the reciprocating linear actuator to an alternative controllable waveform to apply an alternative oscillatory motion to the at least one substance.

4. A method as described in claim 3, wherein the control signal is switched to an alternative waveform in response to conditions within the vessel.

5. A method as described in claim 1, wherein the control signal is adapted to produce a waveform that is substantially sinusoidal.

6. A method as described in claim 1, wherein the control signal is adapted to produce a waveform that is substantially square wave.

7. A method as described in claim 1, wherein the control signal is adapted to produce a waveform that is substantially triangular wave.

8. A method as described in claim 1, wherein the control signal is adapted to produce a waveform that is irregular.

9. A method as described in claim 1, wherein the control signal can be adapted to produce a waveform with constant or variable amplitude.

10. A method as described in claim 1, wherein the control signal can be adapted to produce a waveform with constant or variable frequency.

11. A method as described in claim 1, wherein the control signal can be adapted to produce a waveform with constant or variable period.

12. A method as described in claim 1, wherein on adjustment of the amplitude in a batch apparatus comprising a last baffle, the last baffle is automatically realigned in relation to the bottom of the apparatus.

13. A method as described in claim 1, wherein the reciprocating linear actuator is set at a pre-determined position prior to the start of operation.

14. A method as described in claim 1, wherein the vessel comprises a plurality of annular baffles extending radially inwards from the side of the vessel.

15. An apparatus as described in claim 14, wherein the plurality of annular baffles are static.

16. An apparatus for applying oscillatory motion to at least one substance within a vessel, the apparatus comprising:
a vessel;
a plurality of annular baffles extending radially inwards from the side of the vessel;
a reciprocating linear actuator for applying linear motion to the at least one substance; and
a control means adapted to control the linear movement of the actuator wherein the frequency and amplitude of said linear movement is determined by a control signal generated by the control means, the control signal being generated in accordance with at least one predetermined waveform, and wherein the frequency and amplitude of the linear movement can be altered simultaneously or independently.

17. An apparatus as described in claim 16, wherein the plurality of annular baffles are static.

18. An apparatus as described in claim 16, wherein the control signal has a first predetermined waveform and wherein the control means is adapted to switch the control signal to a second alternative waveform.

19. An apparatus as described in claim 16, wherein at least part of actuator is moveably located within the vessel.

20. An apparatus as described in claim 16, wherein the actuator operates on a diaphragm connected to the vessel.

21. An apparatus as described in claim 16, wherein the actuator operates on bellows connected to the vessel.

22. An apparatus as described in claim 16, wherein the actuator operates on a piston arrangement connected to the vessel.

23. An apparatus as described in claim 16, wherein the actuator comprises a reciprocating shaft.

24. An apparatus as described in claim 23, wherein the actuator further comprises a piston attached to the reciprocating shaft.

25. An apparatus as described in claim 16, wherein the apparatus further comprises at least one baffle set.

26. An apparatus as described in claim 25, wherein the at least one baffle set is attached to a reciprocating shaft so forming an actuator.

27. An apparatus as described in claim 26, wherein the at least one baffle set comprises a plurality of annular baffles, joined together by rails in a substantially equidistant manner, and arranged substantially in parallel, such that they extend radially inwards from the side of the vessel.

28. An apparatus as described in claim 16, wherein the control means is a servo amplifier.

29. An apparatus as described in claim 28, wherein the servo amplifier is a digital servo amplifier.
